(19) United States
(12) Patent Application Publication
(10) Pub. No.: US 2003/0002695 A1
(43) Pub. Date: Jan. 2, 2003

(54) Loudspeaker diaphragm

(75) Inventors: Masanori Takahashi, Yamagata-ken (JP); Tadazumi Hashimoto, Yamagata-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/171,764

(22) Filed: Jun. 14, 2002

(30) Foreign Application Priority Data
Jun. 18, 2001 (JP) 2001-183273

(51) Int. Cl. H04R 3/00

(52) U.S. Cl. 381/111

(57) ABSTRACT

A loudspeaker diaphragm which is light in weight (low in density), good in environmental resistance, high in internal loss, easy to form, and high in degree of flexibility in designing its shape is provided. A polyimide foam material which has been molded into a block of foam having a predetermined thickness is heated and pressed by a die into a loudspeaker diaphragm made of the polyimide foam material.

### BACKGROUND OF THE INVENTION

1. Field of the Invention

The present invention relates to a loudspeaker diaphragm made of a particular foam material.

The present application claims priority from Japanese Application No. 2001-183273, the disclosure of which is incorporated herein by reference for all purposes.

2. Description of the Related Art

Properties required for the material of a loudspeaker diaphragm have to include: (1) a low density ρ to improve performance; (2) a large specific elasticity E/ρ to provide a wide range of reproduction frequencies; and (3) an appropriate internal loss to damp resonance and provide a flat acoustic pressure versus frequency characteristic.

To meet these requirements, polypropylene (hereinafter referred to as PP) or an olefin-based resin has been employed as the material. A diaphragm made of PP has good waterproofness, good appearance, large internal loss, and good physical balance as a loudspeaker diaphragm. This is why polypropylene is currently next to paper in amount of use.

Since PP has a specific gravity of 900 kg/m³ which is greater than that of paper and a Young's modulus which is less than that of paper, a diaphragm made of PP is reinforced with a filler such as carbon fiber to provide a higher rigidity. However, in comparison with paper, this reinforcement leads to a further increase in specific gravity, which results in a decrease in sensitivity and interferes with energy output in a high frequency band.

To address this disadvantage, a resin foam material tends to be used, among other things, as a diaphragm material for a midrange tweeter or the like. An olefin-based or a polyurethane-based resin foam material offers advantages of being light in weight and high in internal loss. However, these resin foam materials have disadvantages of being very bad in resistance to light, degraded in a short period of time due to ultraviolet rays, and problematic in resistance to heat. These disadvantages make the resin foam materials insufficient in reliability when a loudspeaker diaphragm made of the materials is used in a harsh environment such as in vehicles.

In addition to this, to form the loudspeaker diaphragm made of the aforementioned resin foam materials, a foaming resin agent which contains a forming agent is injected into a mold to be foamed therein. This requires a facility for injection molding and a complicated molding process, and reduces the degree of flexibility in designing the shape of the diaphragm due to injection foam molding.

### SUMMARY OF THE INVENTION

The present invention has been suggested to address these problems. It is therefore an object of the present invention to use a polyimide foam material in order to provide a loudspeaker diaphragm which is light in weight (low in density), good in environmental resistance, high in internal loss, easy to be formed, and high in degree of flexibility in designing its shape.

To achieve the aforementioned object, a loudspeaker diaphragm according to the present invention is characterized by being made of a polyimide foam material. In particular, a loudspeaker diaphragm is characterized in that a polyimide foam material is pressure molded into the shape of a diaphragm or a polyimide foam material of continuous foam is pressure molded into a loudspeaker diaphragm of continuous foam.

Furthermore, the loudspeaker diaphragm is characterized in that a surface of the diaphragm is coated with a resin or the diaphragm is shaped in a dome.

The present invention has been suggested with attention being given to the fact that the polyimide foam material has a good property as a material of a loudspeaker diaphragm and that the polyimide foam material of continuous foam has an excellent moldability into a loudspeaker diaphragm. The polyimide foam material is low in density (approximately 8 kg/m³), and this lightness of weight makes it possible to form a highly sensitive loudspeaker diaphragm. Furthermore, the performance of the polyimide foam material includes a high resistance to heat and a self-extinguishing property, thereby providing a loudspeaker diaphragm having a high level of environmental resistance and safety. Furthermore, the structural property of the foaming resin makes it possible to ensure a high internal loss.

Still furthermore, since the polyimide foam material is a continuous foam material having an independent foam ratio of one percent or less, it is possible to mold the foam material into a foam material to be molded having a predetermined thickness and then to pressure mold the foam material to be molded into a loudspeaker diaphragm. In this case, since the foam can maintain its continuous foam property after having been pressure molded, it is possible to provide a loudspeaker diaphragm of an extremely low density. Since the foam can be easily formed only by press cutting, it is possible to freely set the shape of the diaphragm by means of the shape of a press die, thereby allowing good design of shape not only functionality-wise but also appearance-wise.

On the other hand, the loudspeaker diaphragm, made of a continuous foam material, may cause a high degree of air permeability depending on the molding. In this case, to ensure the reproduction of a high frequency band, the surface of the loudspeaker diaphragm has to be coated or impregnated with a resin (emulsion) to thereby reduce the degree of air permeability. A loudspeaker diaphragm made of such a polyimide foam material is suitable, among other things, for a dome-shaped diaphragm having a curved shape.

### BRIEF DESCRIPTION OF THE DRAWINGS

These and other objects and advantages of the present invention will become clear from the following description with reference to the accompanying drawings, wherein:

FIGS. 1(a) to 1(d) show explanatory views illustrating the steps of forming a loudspeaker diaphragm according to the embodiment; and

FIG. 2 is an explanatory graph illustrating the acoustic characteristics of a loudspeaker diaphragm made of a polyimide foam material.

### DETAILED DESCRIPTION OF THE PREFERRED EMBODIMENTS

Now, the present invention will be explained below in accordance with the embodiment. A polyimide foam material (TA-301 made by Toyo Quality One Co., Ltd.) to be molded is a continuous foam having an independent foam ratio of one percent or less and provided with the following properties as shown in the table below.

TABLE 1

| | |
|---|---|
| Density (kg/m³) | 8 |
| Tensile modulus (kgf/cm²) | 33 |
| Tensile strength (kgf/cm²) | 1 |
| Compressive modulus (kgf/cm²) | 3 |
| Compressive strength (kgf/cm²) | 0.07 |
| Heat conductivity (w/mh° C.) | 0.16 |
| Coefficient of linear expansion (1/° C.) | 10 × 10⁻⁵ |
| Ratio of independent foam (%) | 1 or less |

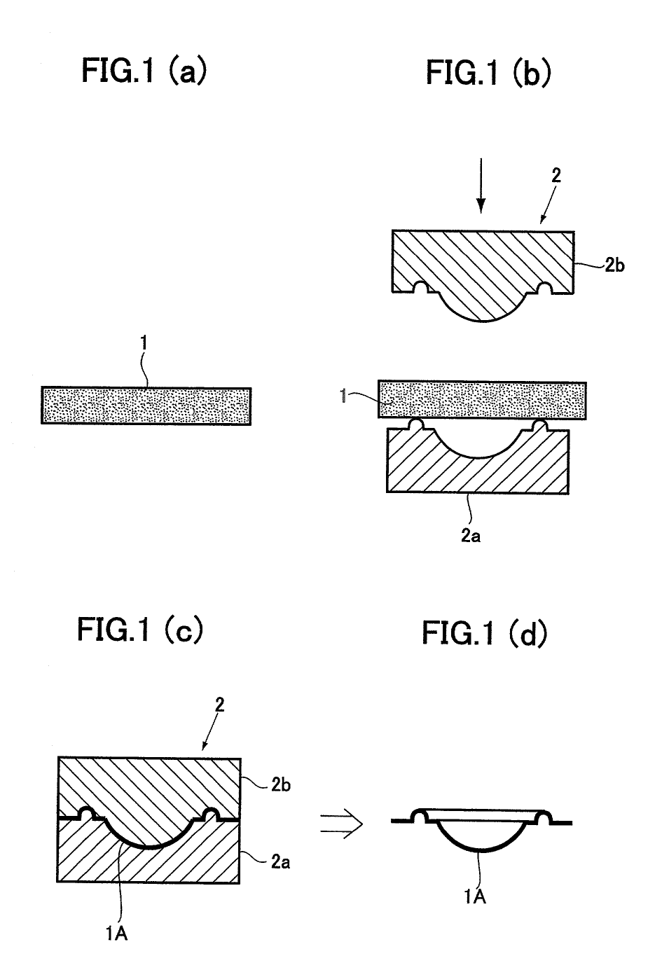

A polyimide foam material having such properties is molded into a block of foam to be molded having a predetermined thickness and then is pressure molded into a loudspeaker diaphragm. FIGS. 1(a) to 1(d) illustrate a producing process of a loudspeaker diaphragm according to the embodiment. In FIG. 1(a), a block of polyimide foam material 1 mentioned above is prepared which has been molded in a thickness of approximately 8 mm. The foam to be molded is placed on a lower die 2a of a die 2 as shown in FIG. 1(b). As shown in FIG. 1(c), an upper die 2b is then pushed against the lower die 2a to allow the foam to be heated and pressed into a loudspeaker diaphragm 1A in the shape of a soft dome (see FIG. 1(d)).

According to this process, since the foam to be molded or the polyimide foam material 1 is a continuous foam material having an independent foam ratio of one percent or less, even the pressure molding allows the foam to subsequently maintain its continuous foam property, thereby making it possible to form a loudspeaker foam material having a low density.

When the foam is heated and pressed, the surface thereof is subjected to heat and thereby its air permeability can be adjusted to some extent. However, for sufficient reproduction of high frequencies, the surface of the loudspeaker diaphragm is coated or impregnated with a resin (emulsion) to reduce air permeability. However, entire elimination of the air permeability would cause the pressure of air present in between the magnetic circuit and the diaphragm to increase when the diaphragm is driven. This in turn causes the diaphragm not to follow sound signals or heat generated from the voice coil not to escape. In consideration of these problems, the amount of resin with which the surface is coated or impregnated is adjusted.

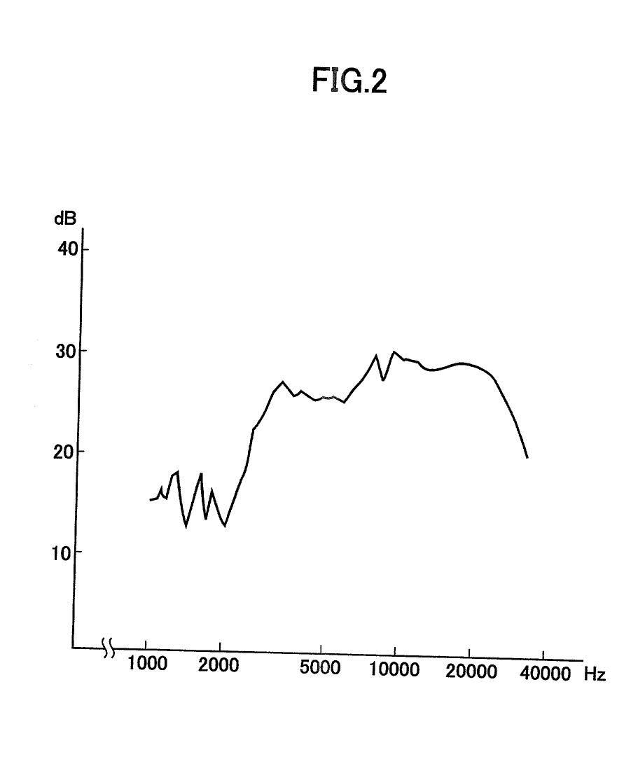

FIG. 2 shows the acoustic characteristics of a loudspeaker diaphragm made of the aforementioned polyimide foam material, the surface of which is coated with an appropriate amount of resin. The acoustic characteristics are provided by examining frequency characteristics at an impedance of 6Ω in the loudspeaker and an input voltage of 2V (at 4,000 Hz) with a microphone being placed 1 m apart from the loudspeaker. Consequently, as shown in the figure, it can be found that there is no irregularities in the frequency versus sound pressure curve in the range of 1,000 to 3,000 Hz and sounds of stable volume can be reproduced.

In addition, the loudspeaker diaphragm made of the polyimide foam material has a weight reduced by 40 to 50 percent in comparison with a diaphragm formed by a piece of conventional cloth being coated or impregnated with a resin (see Japanese Patent Application Laid-Open No. Hei. 11-75289). This inevitably makes it possible to implement a highly sensitive loudspeaker diaphragm. Furthermore, when compared with a diaphragm made of a conventional foam material (such as a fluorine resin foam material) having a high independent foam ratio, the present invention provides a loudspeaker diaphragm which has a higher degree of flexibility in designing its shape and which provides better functionality and design.

Still furthermore, the use of the polyimide foam material makes it possible to form a loudspeaker diaphragm which is provided with environmental resistance such as heat resistance and a self-extinguishing property. This in turn makes it possible to provide a highly stable loudspeaker diaphragm which can be used under a harsh environment such as in vehicles.

Since the present invention is designed as describe above, the use of the polyimide foam material as a diaphragm material makes it possible to provide a loudspeaker diaphragm which is light in weight (low in density), good in environmental resistance, and high in internal loss. The loudspeaker diaphragm can also be easily formed and provided with a high degree of flexibility in designing its shape.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A loudspeaker diaphragm comprising a polyimide foam material.

2. A loudspeaker diaphragm produced by forming a block polyimide foam material to be molded having a predetermined thickness into a shape of a diaphragm.

3. The loudspeaker diaphragm according to claim 1, wherein a surface of the diaphragm is coated or impregnated with a resin.

4. The loudspeaker diaphragm according to claim 2, wherein the foam material to be molded is placed on a diaphragm die to be pressure molded.

5. The loudspeaker diaphragm according to claim 1, wherein the diaphragm is shaped in a dome.

6. The loudspeaker diaphragm according to claim 2, wherein the foam material to be molded is made of a continuous polyimide foam material having an independent foam ratio of one percent or less to form a diaphragm of continuous foam.

7. The loudspeaker diaphragm according to claim 2, wherein a surface of the diaphragm is coated or impregnated with a resin.

8. The loudspeaker diaphragm according to claim 2, wherein the diaphragm is shaped in a dome.
